(19) United States
(12) Patent Application Publication
(10) Pub. No.: US 2017/0063724 A1
(43) Pub. Date: Mar. 2, 2017

(54) ASSET ARRANGEMENT MANAGEMENT FOR A SHARED POOL OF CONFIGURABLE COMPUTING RESOURCES ASSOCIATED WITH A STREAMING APPLICATION

(71) Applicant: International Business Machines Corporation, Armonk, NY (US)

(72) Inventors: Bin Cao, Rochester, MN (US); Jessica R. Eidem, Rochester, MN (US); Brian R. Muras, Otsego, MN (US); Jingdong Sun, Rochester, MN (US)

(21) Appl. No.: 15/048,582

(22) Filed: Feb. 19, 2016

Related U.S. Application Data
(63) Continuation of application No. 14/836,944, filed on Aug. 26, 2015.

(51) Int. Cl. H04L 12/911; G06F 9/455; H04L 12/26

(52) U.S. Cl. CPC H04L 47/823; H04L 43/0876; H04L 43/16; G06F 9/45558; G06F 2009/45595; G06F 2009/4557; G06F 2009/45562

(57) ABSTRACT

Disclosed aspects include managing a set of assets of a shared pool of configurable computing resources associated with a streaming application. A stream of tuples to be processed is received by a plurality of processing elements operating on the shared pool of configurable computing resources having the set of assets. A triggering event which corresponds to a data flow of the stream of tuples is detected. Based on the data flow of the stream of tuples, an asset arrangement with respect to the set of assets is determined and established. In embodiments, the stream of tuples may be processed by the plurality of processing elements operating on the shared pool of configurable computing resources having the set of assets.

### BACKGROUND

This disclosure relates generally to computer systems and, more particularly, relates to managing a set of assets of a shared pool of configurable computing resources associated with a streaming application. The amount of data that needs to be managed by enterprises is increasing. Management of a set of assets may be desired to be performed as efficiently as possible. As data needing to be managed increases, the need for management efficiency may increase.

### SUMMARY

Aspects of the disclosure include managing a set of assets of a shared pool of configurable computing resources associated with a streaming application. A stream of tuples to be processed is received by a plurality of processing elements operating on the shared pool of configurable computing resources having the set of assets. A triggering event which corresponds to a data flow of the stream of tuples is detected. Based on the data flow of the stream of tuples, an asset arrangement with respect to the set of assets is determined and established. In embodiments, the stream of tuples may be processed by the plurality of processing elements operating on the shared pool of configurable computing resources having the set of assets.

Aspects of the disclosure relate to dynamic load-balancing of assets (e.g., virtual machines) based on tuple request demand with respect to stream computing in a cloud environment. If an influx of demand comes into a streams graph running on the cloud, the cloud can be informed of an influx of tuples and migrate virtual machines based on a location of the influx of the tuples as predicted by a projected track (e.g., using a tuple flow direction and streams graph layout). By accounting for the nature of streams, performance or efficiency benefits for cloud management may result (e.g., load balancing, high availability).

The above summary is not intended to describe each illustrated embodiment or every implementation of the present disclosure.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a cloud computing node according to embodiments.

FIG. 2 depicts a cloud computing environment according to embodiments.

FIG. 3 depicts abstraction model layers according to embodiments.

FIG. 4 illustrates an exemplary computing infrastructure to execute a stream computing application according to embodiments.

FIG. 5 illustrates a view of a compute node according to embodiments.

FIG. 6 illustrates a view of a management system according to embodiments.

FIG. 7 illustrates a view of a compiler system according to embodiments.

FIG. 8 illustrates an exemplary operator graph for a stream computing application according to embodiments.

FIG. 9 shows an example system with respect to executing a stream computing application on a shared pool of configurable computing resources having a set of assets according to embodiments.

FIG. 10 is a flowchart illustrating a method for processing a stream of tuples by a plurality of processing elements operating on a shared pool of configurable computing resources having a set of assets according to embodiments.

FIG. 11 is a flowchart illustrating a set of asset arrangement operations according to embodiments.

FIG. 12 is a flowchart illustrating a set of asset arrangement operations according to embodiments.

FIG. 13 is a flowchart illustrating a set of asset arrangement operations according to embodiments.

FIG. 14 is a flowchart illustrating a set of asset arrangement operations according to embodiments.

FIG. 15 is a flowchart illustrating a set of asset arrangement operations according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the disclosure relate to dynamic load-balancing of assets (e.g., virtual machines) based on tuple request demand with respect to stream computing in a cloud environment. If an influx of demand comes into a streams graph running on the cloud, the cloud can be informed of an influx of tuples and migrate virtual machines based on a location of the influx of the tuples as predicted by a projected track (e.g., using a tuple flow direction and streams graph layout). By accounting for the nature of streams, performance or efficiency benefits for cloud management may result (e.g., load balancing, high availability).

Stream-based computing and stream-based database computing are emerging as a developing technology for database systems. Products are available which allow users to create applications that process and query streaming data before it reaches a database file. With this emerging technology, users can specify processing logic to apply to inbound data records while they are “in flight,” with the results available in a very short amount of time, often in fractions of a second. Constructing an application using this type of processing has opened up a new programming paradigm that will allow for development of a broad variety of innovative applications, systems, and processes, as well as present new challenges for application programmers and database developers.

In a stream computing application, stream operators are connected to one another such that data flows from one stream operator to the next (e.g., over a TCP/IP socket). When a stream operator receives data, it may perform operations, such as analysis logic, which may change the tuple by adding or subtracting attributes, or updating the values of existing attributes within the tuple. When the analysis logic is complete, a new tuple is then sent to the next stream operator. Scalability is achieved by distributing an application across nodes by creating executables (i.e., processing elements), as well as replicating processing elements on multiple nodes and load balancing among them. Stream operators in a stream computing application can be fused together to form a processing element that is executable. Doing so allows processing elements to share a common process space, resulting in much faster communication between stream operators than is available using inter-process communication techniques (e.g., using a TCP/IP socket). Further, processing elements can be inserted or removed dynamically from an operator graph representing the flow of data through the stream computing application. A particular stream operator may not reside within the same operating system process as other stream operators. In addition, stream operators in the same operator graph may be hosted on different nodes, e.g., on different compute nodes or on different cores of a compute node.

Data flows from one stream operator to another in the form of a “tuple.” A tuple is a sequence of one or more attributes associated with an entity. Attributes may be any of a variety of different types, e.g., integer, float, Boolean, string, etc. The attributes may be ordered. In addition to attributes associated with an entity, a tuple may include metadata, i.e., data about the tuple. A tuple may be extended by adding one or more additional attributes or metadata to it. As used herein, “stream” or “data stream” refers to a sequence of tuples. Generally, a stream may be considered a pseudo-infinite sequence of tuples.

Tuples are received and output by stream operators and processing elements. An input tuple corresponding with a particular entity that is received by a stream operator or processing element, however, is generally not considered to be the same tuple that is output by the stream operator or processing element, even if the output tuple corresponds with the same entity or data as the input tuple. An output tuple need not be changed in some way from the input tuple.

Nonetheless, an output tuple may be changed in some way by a stream operator or processing element. An attribute or metadata may be added, deleted, or modified. For example, a tuple will often have two or more attributes. A stream operator or processing element may receive the tuple having multiple attributes and output a tuple corresponding with the input tuple. The stream operator or processing element may only change one of the attributes so that all of the attributes of the output tuple except one are the same as the attributes of the input tuple.

Generally, a particular tuple output by a stream operator or processing element may not be considered to be the same tuple as a corresponding input tuple even if the input tuple is not changed by the processing element. However, to simplify the present description and the claims, an output tuple that has the same data attributes or is associated with the same entity as a corresponding input tuple will be referred to herein as the same tuple unless the context or an express statement indicates otherwise.

Stream computing applications handle massive volumes of data that need to be processed efficiently and in real time. For example, a stream computing application may continuously ingest and analyze hundreds of thousands of messages per second and up to petabytes of data per day. Accordingly, each stream operator in a stream computing application may be required to process a received tuple within fractions of a second. Unless the stream operators are located in the same processing element, it is necessary to use an inter-process communication path each time a tuple is sent from one stream operator to another. Inter-process communication paths can be a critical resource in a stream computing application. According to various embodiments, the available bandwidth on one or more inter-process communication paths may be conserved. Efficient use of inter-process communication bandwidth can speed up processing.

A streams processing job has a directed graph of processing elements that send data tuples between the processing elements. The processing element operates on the incoming tuples, and produces output tuples. A processing element has an independent processing unit and runs on a host. The streams platform can be made up of a collection of hosts that are eligible for processing elements to be placed upon. When a job is submitted to the streams run-time, the platform scheduler processes the placement constraints on the processing elements, and then determines (the best) one of these candidates host for (all) the processing elements in that job, and schedules them for execution on the decided host.

Aspects of the disclosure include a method, system, and computer program product for processing a stream of tuples by a plurality of processing elements operating on a shared pool of configurable computing resources having a set of assets. The stream of tuples to be processed is received by the plurality of processing elements operating on the shared pool of configurable computing resources having the set of assets. A triggering event which corresponds to a data flow of the stream of tuples is detected. Based on the data flow of the stream of tuples, an asset arrangement with respect to the set of assets is determined and established. In embodiments, the stream of tuples may be processed by the plurality of processing elements operating on the shared pool of configurable computing resources having the set of assets. Altogether, performance or efficiency benefits with respect to stream computing in a cloud environment may occur (e.g., speed, flexibility, load balancing, responsiveness, high availability, resource usage, productivity). Aspects may save resources such as bandwidth, processing, or memory.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for loadbalancing between clouds).

A cloud computing environment is service oriented with a focus on statelessness, low coupling, modularity, and semantic interoperability. At the heart of cloud computing is an infrastructure comprising a network of interconnected nodes.

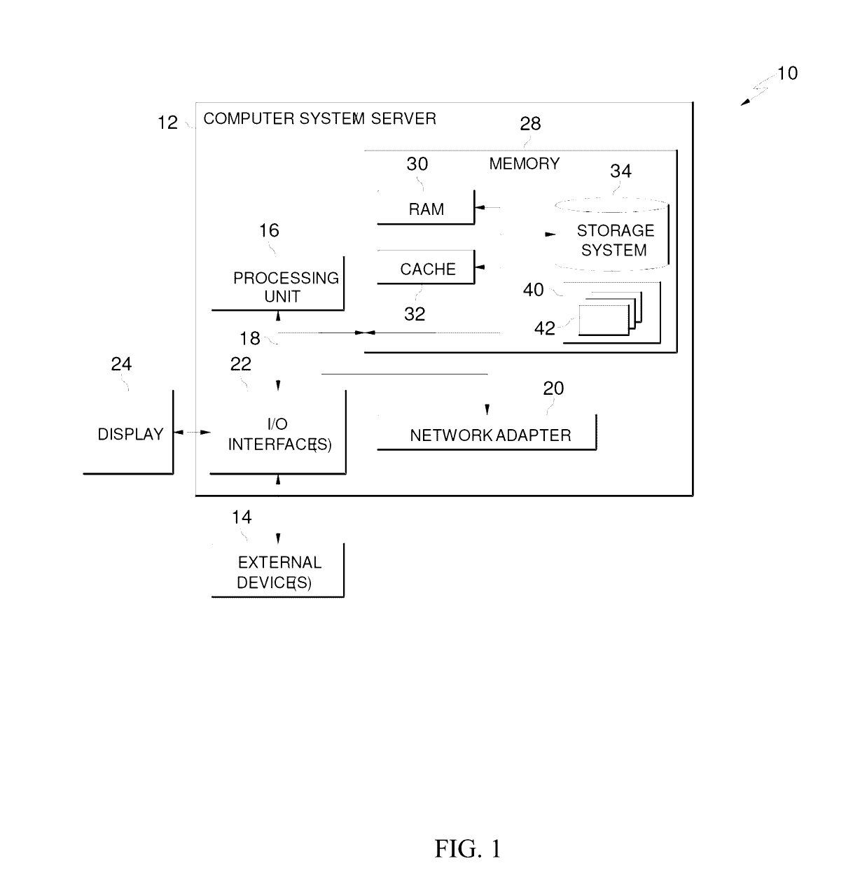

Referring now to FIG. 1, a schematic of an example of a cloud computing node is shown. Cloud computing node 10 is only one example of a suitable cloud computing node and is not intended to suggest any limitation as to the scope of use or functionality of embodiments of the disclosure described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the disclosure as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

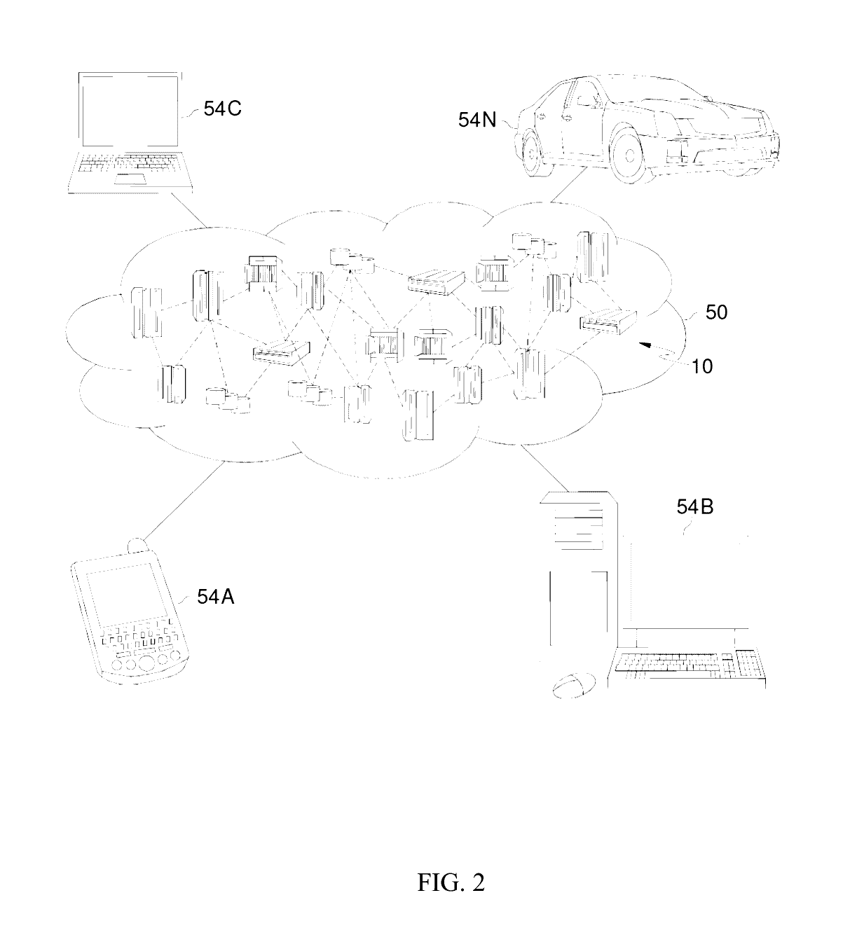

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

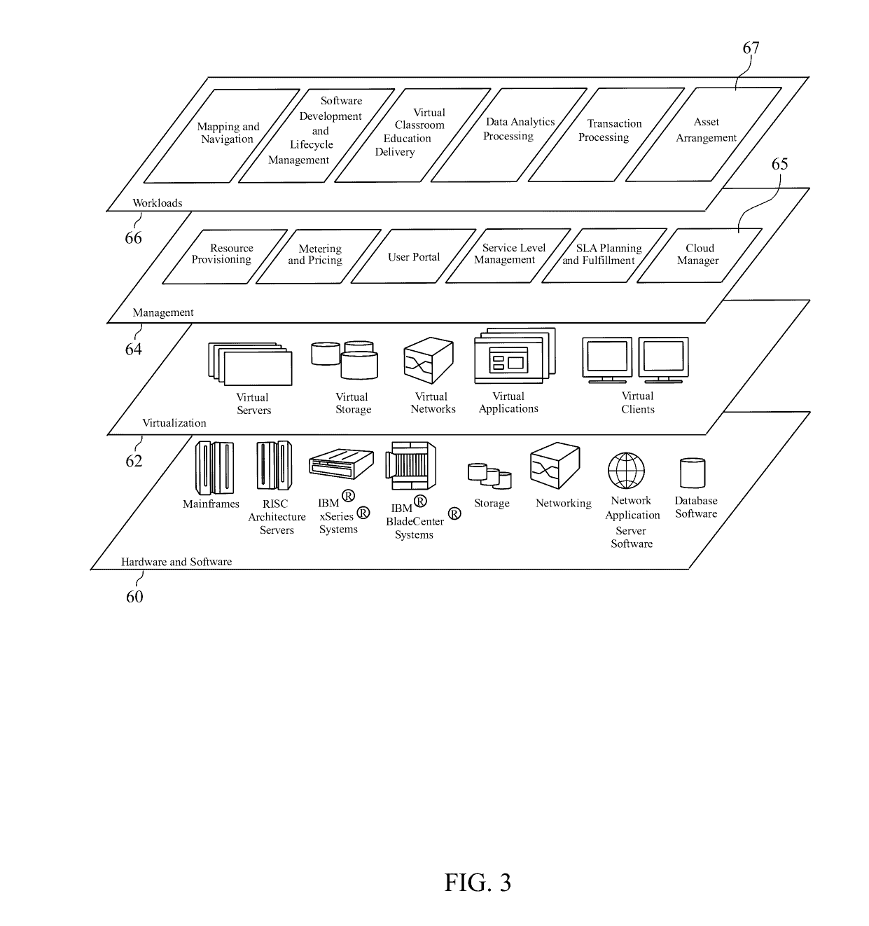

Referring now to FIG. 3, a set of functional abstraction layers provided by cloud computing environment 50 in FIG. 2 is shown. It should be understood in advance that the components, layers, and functions shown in FIG. 3 are intended to be illustrative only and the disclosure and claims are not limited thereto. As depicted, the following layers and corresponding functions are provided.

Hardware and software layer 60 includes hardware and software components. Examples of hardware components include mainframes, in one example IBM System z systems; RISC (Reduced Instruction Set Computer) architecture based servers, in one example IBM Power Systems; IBM System x systems; IBM BladeCenter systems; storage devices; networks and networking components. Examples of software components include network application server software, in one example IBM Web Sphere® application server software; database software, in one example IBM DB2® database software; and streaming software, in one example IBM InfoSphere® Streams stream computing software. IBM, System z, Power Systems, System x, BladeCenter, InfoSphere, WebSphere, and DB2 are trademarks of International Business Machines Corporation registered in many jurisdictions worldwide.

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA. A cloud manager 65 is representative of a cloud manager (or shared pool manager) as described in more detail below. While the cloud manager 65 is shown in FIG. 3 to reside in the management layer 64, cloud manager 65 can span all of the levels shown in FIG. 3, as discussed below.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and an asset arrangement 67, which may be utilized as discussed in more detail below.

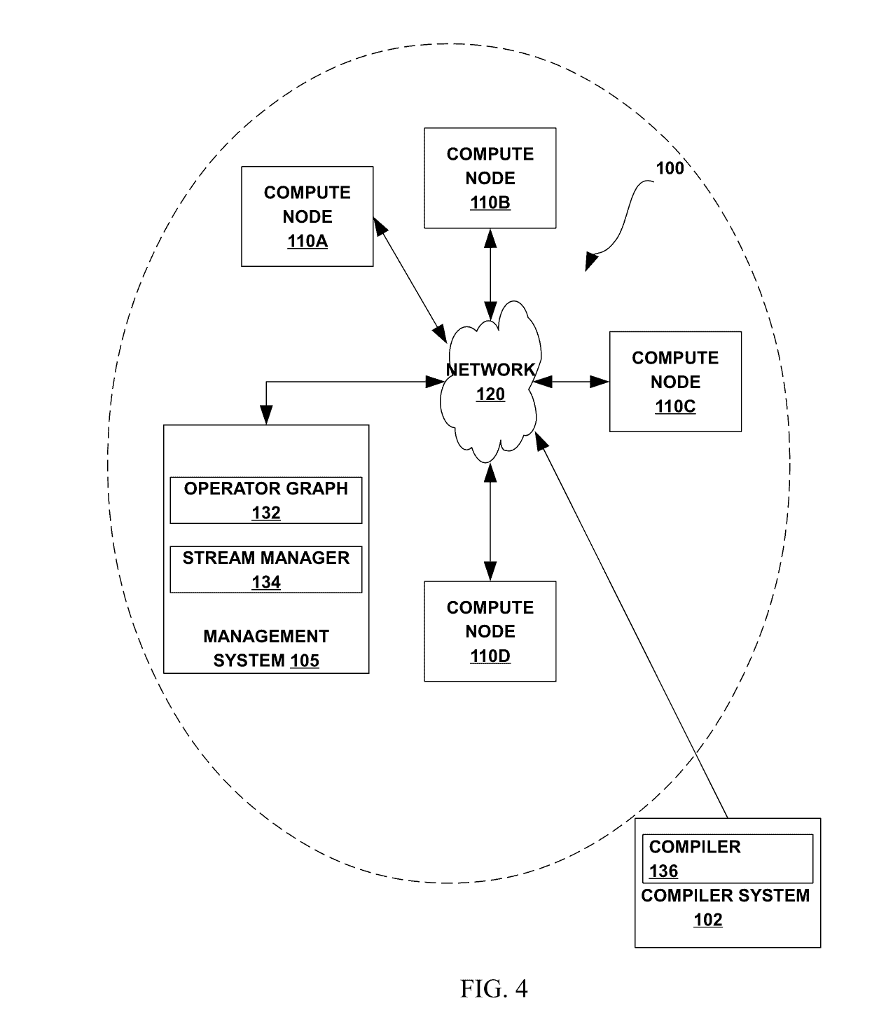

FIG. 4 illustrates one exemplary computing infrastructure 100 that may be configured to execute a stream computing application, according to some embodiments. The computing infrastructure 100 includes a management system 105 and two or more compute nodes 110A—110D—i.e., hosts—which are communicatively coupled to each other using one or more communications networks 120. The communications network 120 may include one or more servers, networks, or databases, and may use a particular communication protocol to transfer data between the compute nodes 110A—110D. A compiler system 102 may be communicatively coupled with the management system 105 and the compute nodes 110 either directly or via the communications network 120.

The communications network 120 may include a variety of types of physical communication channels or “links.” The links may be wired, wireless, optical, or any other suitable media. In addition, the communications network 120 may include a variety of network hardware and software for performing routing, switching, and other functions, such as routers, switches, or bridges. The communications network 120 may be dedicated for use by a stream computing application or shared with other applications and users. The communications network 120 may be any size. For example, the communications network 120 may include a single local area network or a wide area network spanning a large geographical area, such as the Internet. The links may provide different levels of bandwidth or capacity to transfer data at a particular rate. The bandwidth that a particular link provides may vary depending on a variety of factors, including the type of communication media and whether particular network hardware or software is functioning correctly or at full capacity. In addition, the bandwidth that a particular link provides to a stream computing application may vary if the link is shared with other applications and users. The available bandwidth may vary depending on the load placed on the link by the other applications and users. The bandwidth that a particular link provides may also vary depending on a temporal factor, such as time of day, day of week, day of month, or season.

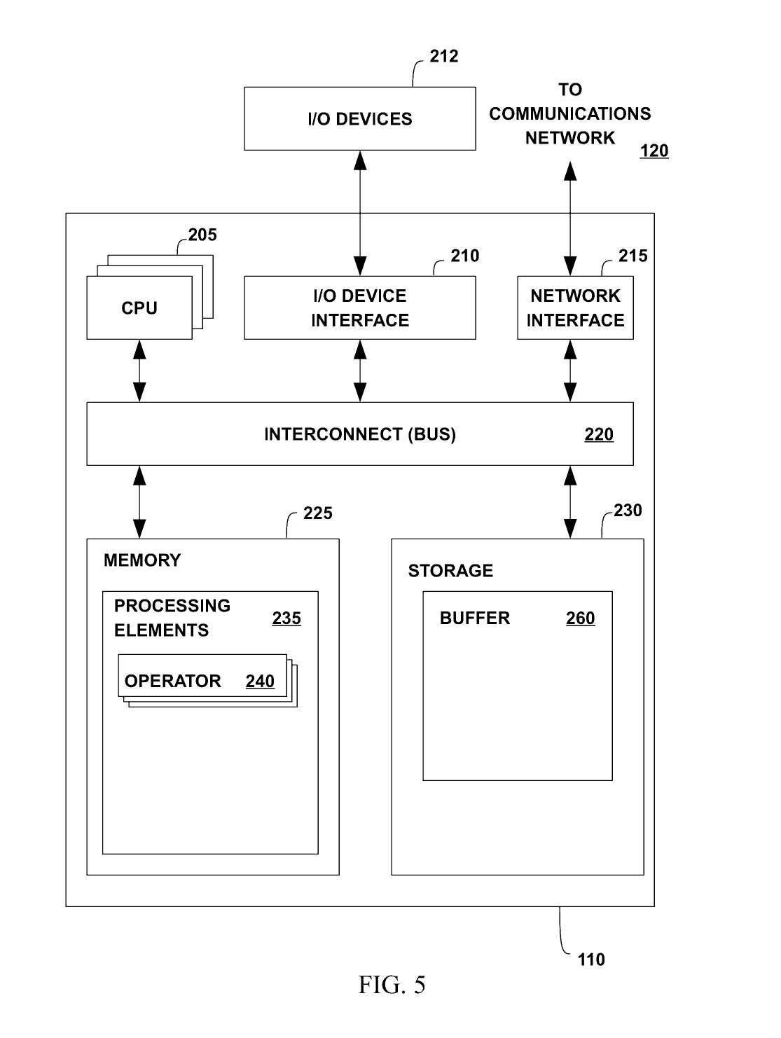

FIG. 5 is a more detailed view of a compute node 110, which may be the same as one of the compute nodes 110A-110D of FIG. 4, according to various embodiments. The compute node 110 may include, without limitation, one or more processors (CPUs) 205, a network interface 215, an interconnect 220, a memory 225, and a storage 230. The compute node 110 may also include an I/O device interface 210 used to connect I/O devices 212, e.g., keyboard, display, and mouse devices, to the compute node 110.

Each CPU 205 retrieves and executes programming instructions stored in the memory 225 or storage 230. Similarly, the CPU 205 stores and retrieves application data residing in the memory 225. The interconnect 220 is used to transmit programming instructions and application data between each CPU 205, I/O device interface 210, storage 230, network interface 215, and memory 225. The interconnect 220 may be one or more busses. The CPUs 205 may be a single CPU, multiple CPUs, or a single CPU having multiple processing cores in various embodiments. In one embodiment, a processor 205 may be a digital signal processor (DSP). One or more processing elements 235 (described below) may be stored in the memory 225. A processing element 235 may include one or more stream operators 240 (described below). In one embodiment, a processing element 235 is assigned to be executed by only one CPU 205, although in other embodiments the stream operators 240 of a processing element 235 may include one or more threads that are executed on two or more CPUs 205. The memory 225 is generally included to be representative of a random access memory, e.g., Static Random Access Memory (SRAM), Dynamic Random Access Memory (DRAM), or Flash. The storage 230 is generally included to be representative of a non-volatile memory, such as a hard disk drive, solid state device (SSD), or removable memory cards, optical storage, flash memory devices, network attached storage (NAS), or connections to storage area network (SAN) devices, or other devices that may store non-volatile data. The network interface 215 is configured to transmit data via the communications network 120.

A stream computing application may include one or more stream operators 240 that may be compiled into a “processing element” container 235. The memory 225 may include two or more processing elements 235, each processing element having one or more stream operators 240. Each stream operator 240 may include a portion of code that processes tuples flowing into a processing element and outputs tuples to other stream operators 240 in the same processing element, in other processing elements, or in both the same and other processing elements in a stream computing application. Processing elements 235 may pass tuples to other processing elements that are on the same compute node 110 or on other compute nodes that are accessible via communications network 120. For example, a processing element 235 on compute node 110A may output tuples to a processing element 235 on compute node 110B.

The storage 230 may include a buffer 260. Although shown as being in storage, the buffer 260 may be located in the memory 225 of the compute node 110 or in a combination of both memories. Moreover, storage 230 may include storage space that is external to the compute node 110, such as in a cloud.

The compute node 110 may include one or more operating systems 262. An operating system 262 may be stored partially in memory 225 and partially in storage 230. Alternatively, an operating system may be stored entirely in memory 225 or entirely in storage 230. The operating system provides an interface between various hardware resources, including the CPU 205, and processing elements and other components of the stream computing application. In addition, an operating system provides common services for application programs, such as providing a time function.

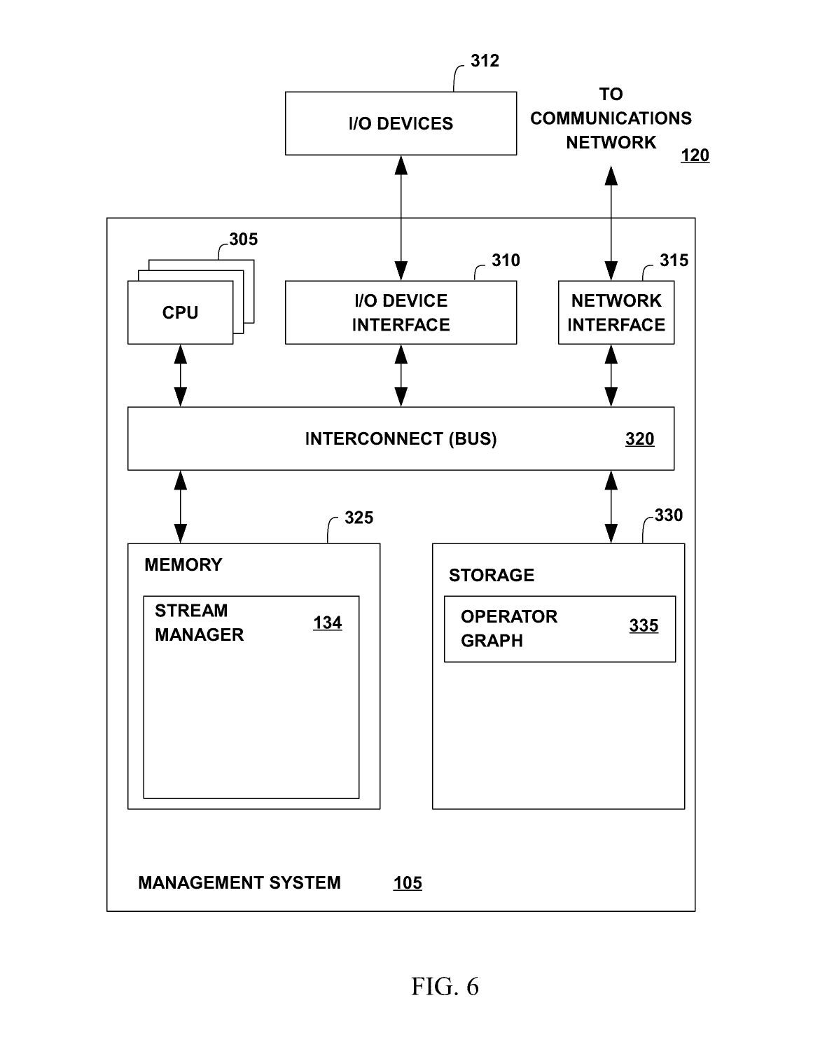

FIG. 6 is a more detailed view of the management system 105 of FIG. 4 according to some embodiments. The management system 105 may include, without limitation, one or more processors (CPUs) 305, a network interface 315, an interconnect 320, a memory 325, and a storage 330. The management system 105 may also include an I/O device interface 310 connecting I/O devices 312, e.g., keyboard, display, and mouse devices, to the management system 105.

Each CPU 305 retrieves and executes programming instructions stored in the memory 325 or storage 330. Similarly, each CPU 305 stores and retrieves application data residing in the memory 325 or storage 330. The interconnect 320 is used to move data, such as programming instructions and application data, between the CPU 305, I/O device interface 310, storage unit 330, network interface 315, and memory 325. The interconnect 320 may be one or more busses. The CPUs 305 may be a single CPU, multiple CPUs, or a single CPU having multiple processing cores in various embodiments. In one embodiment, a processor 305 may be a DSP. Memory 325 is generally included to be representative of a random access memory, e.g., SRAM, DRAM, or Flash. The storage 330 is generally included to be representative of a non-volatile memory, such as a hard disk drive, solid state device (SSD), removable memory cards, optical storage, Flash memory devices, network attached storage (NAS), connections to storage area-network (SAN) devices, or the cloud. The network interface 315 is configured to transmit data via the communications network 120.

The memory 325 may store a stream manager 134. Additionally, the storage 330 may store an operator graph 335. The operator graph 335 may define how tuples are routed to processing elements 235 (FIG. 5) for processing or stored in memory 325 (e.g., completely in embodiments, partially in embodiments).

The management system 105 may include one or more operating systems 332. An operating system 332 may be stored partially in memory 325 and partially in storage 330. Alternatively, an operating system may be stored entirely in memory 325 or entirely in storage 330. The operating system provides an interface between various hardware resources, including the CPU 305, and processing elements and other components of the stream computing application. In addition, an operating system provides common services for application programs, such as providing a time function.

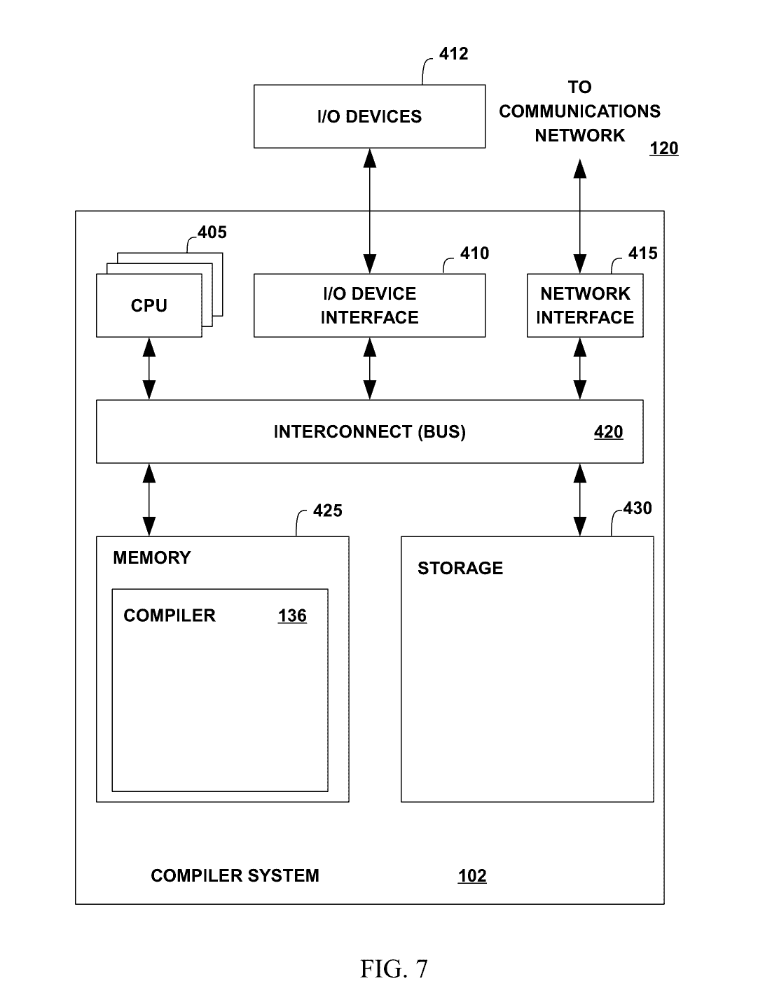

FIG. 7 is a more detailed view of the compiler system 102 of FIG. 4 according to some embodiments. The compiler system 102 may include, without limitation, one or more processors (CPUs) 405, a network interface 415, an interconnect 420, a memory 425, and storage 430. The compiler system 102 may also include an I/O device interface 410 connecting I/O devices 412, e.g., keyboard, display, and mouse devices, to the compiler system 102.

Each CPU 405 retrieves and executes programming instructions stored in the memory 425 or storage 430. Similarly, each CPU 405 stores and retrieves application data residing in the memory 425 or storage 430. The interconnect 420 is used to move data, such as programming instructions and application data, between the CPU 405, I/O device interface 410, storage unit 430, network interface 415, and memory 425. The interconnect 420 may be one or more busses. The CPUs 405 may be a single CPU, multiple CPUs, or a single CPU having multiple processing cores in various embodiments. In one embodiment, a processor 405 may be a DSP. Memory 425 is generally included to be representative of a random access memory, e.g., SRAM, DRAM, or Flash. The storage 430 is generally included to be representative of a non-volatile memory, such as a hard disk drive, solid state device (SSD), removable memory cards, optical storage, flash memory devices, network attached storage (NAS), connections to storage area-network (SAN) devices, or to the cloud. The network interface 415 is configured to transmit data via the communications network 120.

The compiler system 102 may include one or more operating systems 432. An operating system 432 may be stored partially in memory 425 and partially in storage 430. Alternatively, an operating system may be stored entirely in memory 425 or entirely in storage 430. The operating system provides an interface between various hardware resources, including the CPU 405, and processing elements and other components of the stream computing application. In addition, an operating system provides common services for application programs, such as providing a time function.

The memory 425 may store a compiler 136. The compiler 136 compiles modules, which include source code or statements, into the object code, which includes machine instructions that execute on a processor. In one embodiment, the compiler 136 may translate the modules into an intermediate form before translating the intermediate form into object code. The compiler 136 may output a set of deployable artifacts that may include a set of processing elements and an application description language file (ADL file), which is a configuration file that describes the stream computing application. In some embodiments, the compiler 136 may be a just-in-time compiler that executes as part of an interpreter. In other embodiments, the compiler 136 may be an optimizing compiler. In various embodiments, the compiler 136 may perform peephole optimizations, local optimizations, loop optimizations, inter-procedural or whole-program optimizations, machine code optimizations, or any other optimizations that reduce the amount of time required to execute the object code, to reduce the amount of memory required to execute the object code, or both. The output of the compiler 136 may be represented by an operator graph, e.g., the operator graph 335.

The compiler 136 may also provide the application administrator with the ability to optimize performance through profile-driven fusion optimization. Fusing operators may improve performance by reducing the number of calls to a transport. While fusing stream operators may provide faster communication between operators than is available using inter-process communication techniques, any decision to fuse operators requires balancing the benefits of distributing processing across multiple compute nodes with the benefit of faster inter-operator communications. The compiler 136 may automate the fusion process to determine how to best fuse the operators to be hosted by one or more processing elements, while respecting user-specified constraints. This may be a two-step process, including compiling the application in a profiling mode and running the application, then re-compiling and using the optimizer during this subsequent compilation. The end result may, however, be a compiler-supplied deployable application with an optimized application configuration.

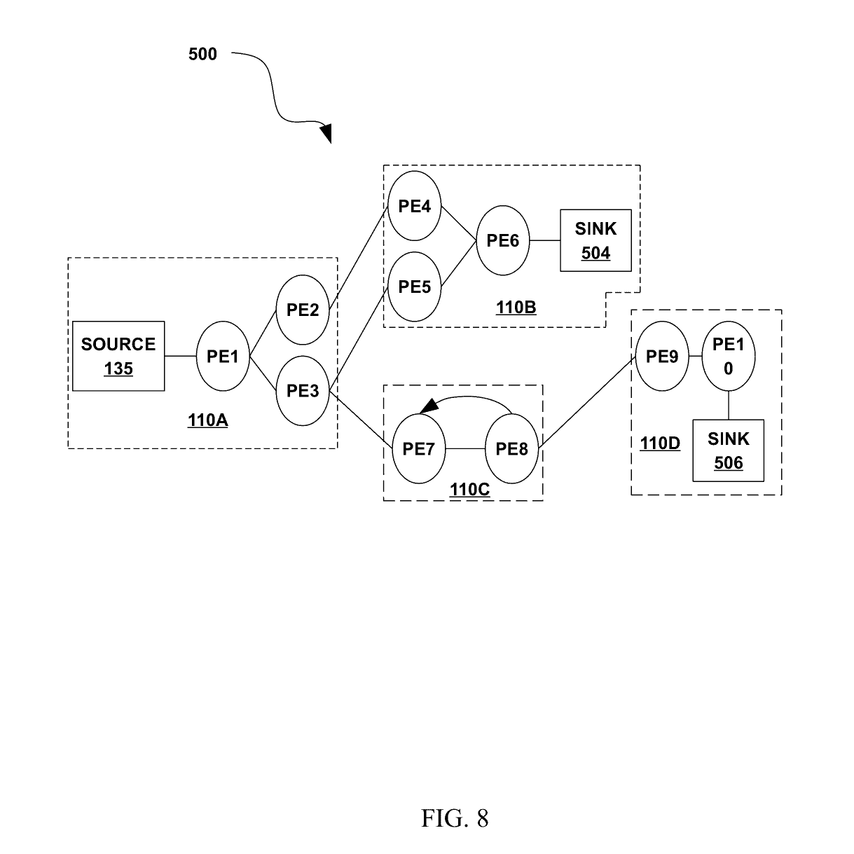

FIG. 8 illustrates an exemplary operator graph 500 for a stream computing application beginning from one or more sources 135 through to one or more sinks 504, 506, according to some embodiments. This flow from source to sink may also be generally referred to herein as an execution path. In addition, a flow from one processing element to another may be referred to as an execution path in various contexts. Although FIG. 8 is abstracted to show connected processing elements PE1-PE10, the operator graph 500 may include data flows between stream operators 240 (FIG. 5) within the same or different processing elements. Typically, processing elements, such as processing element 235 (FIG. 5), receive tuples from the stream as well as output tuples into the stream (except for a sink—where the stream terminates, or a source—where the stream begins). While the operator graph 500 includes a relatively small number of components, an operator graph may be much more complex and may include many individual operator graphs that may be statically or dynamically linked together.

The example operator graph shown in FIG. 8 includes ten processing elements (labeled as PE1-PE10) running on the compute nodes 110A-110D. A processing element may include one or more stream operators fused together to form an independently running process with its own process ID (PID) and memory space. In cases where two (or more) processing elements are running independently, inter-process communication may occur using a “transport,” e.g., a network socket, a TCP/IP socket, or shared memory. Inter-process communication paths used for inter-process communications can be a critical resource in a stream computing application. However, when stream operators are fused together, the fused stream operators can use more rapid communication techniques for passing tuples among stream operators in each processing element.

The operator graph 500 begins at a source 135 and ends at a sink 504, 506. Compute node 110A includes the processing elements PE1, PE2, and PE3. Source 135 flows into the processing element PE1, which in turn outputs tuples that are received by PE2 and PE3. For example, PE1 may split data attributes received in a tuple and pass some data attributes in a new tuple to PE2, while passing other data attributes in another new tuple to PE3. As a second example, PE1 may pass some received tuples to PE2 while passing other tuples to PE3. Tuples that flow to PE2 are processed by the stream operators contained in PE2, and the resulting tuples are then output to PE4 on compute node 110B. Likewise, the tuples output by PE4 flow to operator sink PE6 504. Similarly, tuples flowing from PE3 to PE5 also reach the operators in sink PE6 504. Thus, in addition to being a sink for this example operator graph, PE6 could be configured to perform a join operation, combining tuples received from PE4 and PE5. This example operator graph also shows tuples flowing from PE3 to PE7 on compute node 110C, which itself shows tuples flowing to PE8 and looping back to PE7. Tuples output from PE8 flow to PE9 on compute node 110D, which in turn outputs tuples to be processed by operators in a sink processing element, for example PE10 506.

Processing elements 235 (FIG. 5) may be configured to receive or output tuples in various formats, e.g., the processing elements or stream operators could exchange data marked up as XML, documents. Furthermore, each stream operator 240 within a processing element 235 may be configured to carry out any form of data processing functions on received tuples, including, for example, writing to database tables or performing other database operations such as data joins, splits, reads, etc., as well as performing other data analytic functions or operations.

The stream manager 134 of FIG. 4 may be configured to monitor a stream computing application running on compute nodes, e.g., compute nodes 110A-110D, as well as to change the deployment of an operator graph, e.g., operator graph 132. The stream manager 134 may move processing elements from one compute node 110 to another, for example, to manage the processing loads of the compute nodes 110A-110D in the computing infrastructure 100. Further, stream manager 134 may control the stream computing application by inserting, removing, fusing, un-fusing, or otherwise modifying the processing elements and stream operators (or what tuples flow to the processing elements) running on the compute nodes 110A-110D.

Because a processing element may be a collection of fused stream operators, it is equally correct to describe the operator graph as one or more execution paths between specific stream operators, which may include execution paths to different stream operators within the same processing element. FIG. 8 illustrates execution paths between processing elements for the sake of clarity.

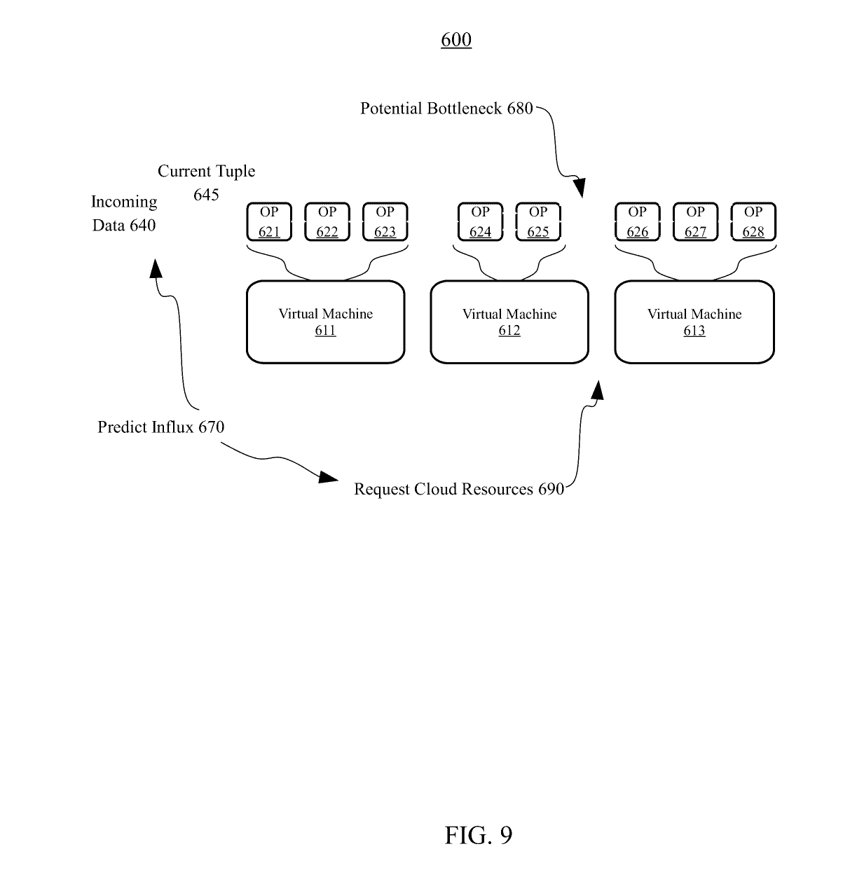

FIG. 9 shows an example system 600 with respect to executing a stream computing application on a shared pool of configurable computing resources having a set of assets according to embodiments. Aspects of the example system 600 includes a streams graph (e.g, including operators 621-628) running on a shared pool of configurable computing resources (e.g, a cloud environment with virtual machines 611-613). When an influx of demand (e.g., incoming data 640, current tuple 645) enters a streams graph, the cloud can be informed of the influx (e.g., by predicting the influx 670) or potential bottleneck 680. As such, a request for cloud resources 690 may be made.

The cloud manager can migrate virtual machines based on a current location of the influx tuples or a projected track of the influx tuples. Such action may be beneficial in a streams-cloud environment because of an ability in the streams-cloud environment to predict the tuple flow direction. The request for additional cloud resources can be sent to a cloud manager. In embodiments, the cloud manager may allocate additional cloud resources (e.g., processor, memory, storage) to an existing virtual machine (e.g., dynamic resize). In embodiments, the cloud manager may deploy a new virtual machine to support existing/new operators. Accordingly, both the virtual machine and the operators can be cloned to accommodate future demand.

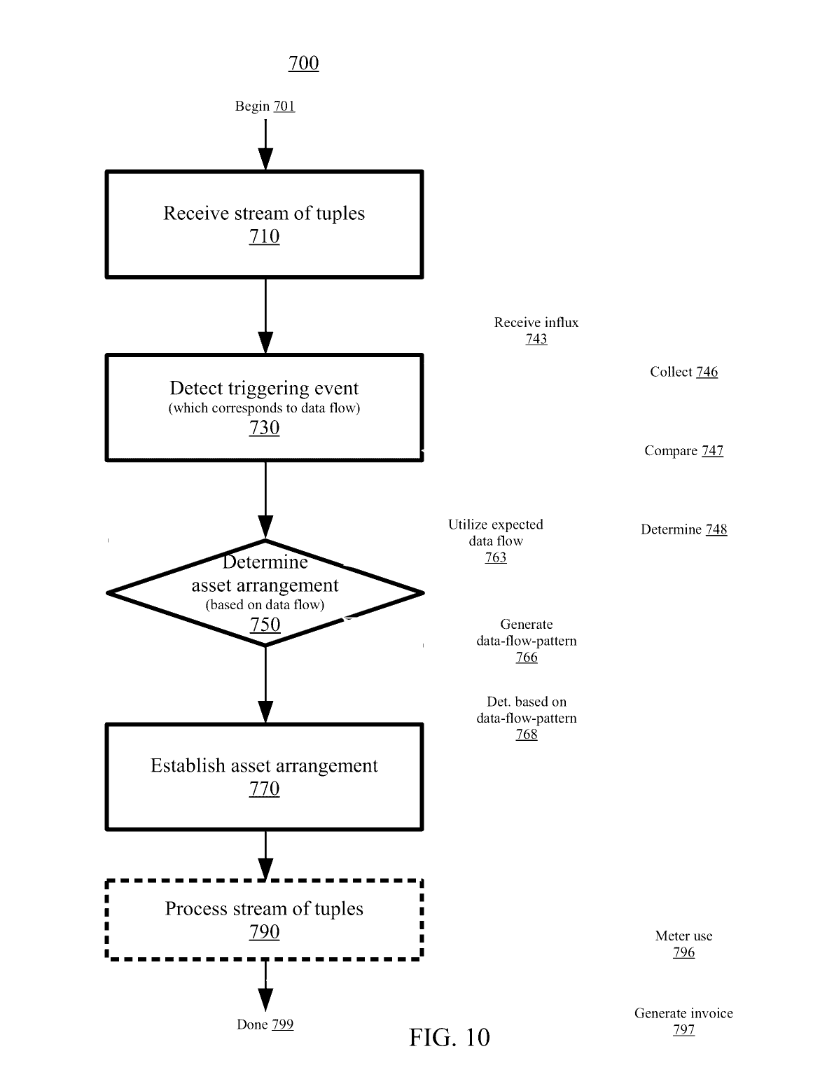

FIG. 10 is a flowchart illustrating a method 700 for processing a stream of tuples by a plurality of processing elements operating on a shared pool of configurable computing resources having a set of assets according to embodiments. The shared pool of configurable computing resources may include a set of compute nodes. For example, the set of compute nodes can be a public cloud environment, a private cloud environment, or a hybrid cloud environment. In certain embodiments, each of the set of compute nodes are physically separate from one another. Method 700 may begin at block 701.

At block 710, the stream of tuples is received. The stream of tuples is to be processed by the plurality of processing elements operating on the shared pool of configurable computing resources having the set of assets. The stream of tuples may be received consistent with the description herein including FIGS. 1-9. Current/future processing by the plurality of processing elements may be performed consistent with the description herein including FIGS. 1-9. The set of assets may include a set of virtual machines (e.g., virtual resources such as virtual machines, virtual disks, or virtual networks). The set of virtual machines may be included in the shared pool of configurable computing resources. As such, the set of virtual machines may run on the set of compute nodes.

At block 730, a triggering event which corresponds to a data flow of the stream of tuples is detected. Detecting can include receiving, sensing, measuring (a change), or scanning (and making an identification). In embodiments, detecting the triggering event which corresponds to the data flow of the stream of tuples includes receiving an influx of demand which corresponds to the data flow of the stream of tuples at block 743. For example, an increase in a quantity of data to be processed entering a streaming application may occur. Such increase may impact resources such as processor or memory. The influx of demand may be a result of increased user activity (e.g., a television commercial during a highly watched sporting event results in a flood of users accessing a particular online service during a narrow time period). The influx of demand can occur in response to another application dumping a large amount of data to be processed (e.g., a major natural disaster occurs across the globe and world leaders seek to understand the ramifications as quickly as possible based on the information gathered with respect to such historical occurrences). In another example, a period of idleness may be detected which may lead to a reconfiguration which uses fewer/less virtual resources (e.g., to reduce burdens/costs).

Detecting the triggering event which corresponds to the data flow of the stream of tuples can include a set of operations. In embodiments, a data flow value (e.g., 7 terabytes per second) of the data flow is collected at block 746. The data flow value may be compared with a threshold value (e.g., 5 terabytes per second) at block 747. The threshold value may be predetermined, user-defined, randomly-generated, based in-part on the current asset configuration, or machine-learned based on historical data. The data flow value can be determined to exceed (e.g., 7>5) the threshold value at block 748. As such, the triggering event may be indicated/detected. As another example, if the current asset configuration has 10 virtual machines are deployed which can handle 2 terabytes per second (and more is needed), then if 20 virtual machines deployed it may handle 4 terabytes per second. Other possibilities for the triggering event are contemplated including those having user intervention.

At block 750, based on the data flow of the stream of tuples, an asset arrangement with respect to the set of assets is determined. The asset arrangement may include a configuration of the set of assets. Considerations for the asset arrangement can include a relationship to data flow (e.g., influx of demand) such as hardware/resource requirements and anticipated usage of resources. For example, the asset arrangement can indicate a quantity, size, or type of a set of virtual machines to be run on one or more hosts. Such indications may include processor, memory, or bandwidth considerations. Various combinations or permutations of the set of assets may be considered based on the data flow. For example, a first stage of a streaming application may desire relatively more memory/storage resources (with respect to a baseline/benchmark) whereas a second stage of the streaming application may desire relatively more processor resources (with respect to the baseline/benchmark). As such, when a potential bottleneck is identified due to an influx of demand being predicted, it may be determined to selectively request additional assets (e.g., cloud resources). Operators may be added, subtracted/removed, or moved/shifted to positively impact the configuration of the asset arrangement.

In embodiments, determining the asset arrangement based on the data flow of the stream of tuples includes utilizing an expected data flow of the stream of tuples at block 763. The data flow may include a first set of locations of the stream of tuples. The expected data flow can include a second set of locations of the stream of tuples. As such, by computing a data path from a first location to a second location, the expected data flow may be deciphered and utilized in arranging assets (e.g., virtual machines, processors, memory). For instance, candidate data paths may be similar to an interstate highway system connecting a city on the west coast with a city on the east coast. Similar to traffic flow, data flow may be predicted and power supplied (e.g., processors in the case of data similar to gas stations in the case of highway traffic).

In embodiments, determining the asset arrangement based on the data flow of the stream of tuples includes utilizing a data-flow-pattern which is based on historical data flow and configured to predict future data flow. The data-flow-pattern may be generated at block 766 using a machine learning technique. Based on the data-flow-pattern, the asset arrangement may be determined at block 768. For instance, history of sequences of a data path over time may indicate future data paths. For example, as new virtual machines are introduced, data flow may change in predictable ways. To illustrate, consider two new interstate highways which connect the west coast and the east coast. The first allows only small cars and the second allows only large commercial trucks. Preexisting interstate highways may still be utilized, but traffic may now be decreased and destinations reached quicker—different gas stations may be utilized even on the same trip. The new first highway, allowing only small cars, may significantly decrease time spent traveling from coast-to-coast and have an entirely new set of gas stations. The new second highway, allowing only large commercial trucks, may similarly streamline operations by being strategically placed where truck-traffic can efficiently bypass slow-downs in large cities. As such, if an influx of traffic begins on the west coast, potential bottlenecks in the midwest may be deterred by rerouting traffic through new or resized highways. Similarly, data flow may be efficiently channeled by similar patterns using assets such as virtual machines, processors, or memory. Historical usages of particular types of tuples can indicate types of processing that may occur (e.g., the nature of which virtual machines to create/resize/reconfigure). As such, future data flow can be predicted with respect to various configurations (e.g., with respect to load balancing, with respect to high availability) when, for example, an influx of demand is detected. Altogether, the data-flow-pattern can provide performance or efficiency benefits in developing the asset arrangement.

At block 770, the asset arrangement with respect to the set of assets is established (e.g., created, generated). The asset arrangement can be established to process the stream of tuples (e.g., using one or more generated/resized virtual machines). In embodiments, establishing the asset arrangement with respect to the set of assets includes initiating-deployment/deploying a virtual machine, sizing the virtual machine, resizing the virtual machine, reorganizing operators, providing a processing resource (e.g., 8 type X processors), providing a memory resource (e.g., 5 gigabytes of type Y memory), or providing a disk resource (e.g., 2 type Z disk drives having 10 total terabytes of storage).

In embodiments, the stream of tuples is processed at block 790. The stream of tuples may be processed by the plurality of processing elements operating on the shared pool of configurable computing resources having the set of assets. The stream of tuples may be processed consistent with the description herein including FIGS. 1-9. The asset arrangement may be utilized to process the stream of tuples (in response to being established). Processing, utilizing the asset arrangement, of the stream of tuples may provide various flexibilities for the shared pool of configurable computing resources (e.g., the set of compute nodes running the set of virtual machines). Overall flow (e.g., data flow) may be positively impacted by utilizing the asset arrangement. In certain embodiments, use of the plurality of processing elements operating on the shared pool of configurable computing resources having the set of assets (or the asset arrangement) can be metered at block 796 and an invoice can be generated based on the metered use at block 797.

Method 700 concludes at block 799. Aspects of method 700 may provide performance or efficiency benefits for processing a stream of tuples. For example, aspects of method 700 may have positive impacts with respect to load balancing or high availability of a shared pool of configurable computing resources. Altogether, performance or efficiency benefits for processing a stream of tuples by a plurality of processing elements operating on a shared pool of configurable computing resources having a set of assets may occur (e.g., speed, flexibility, responsiveness, resource usage, productivity).

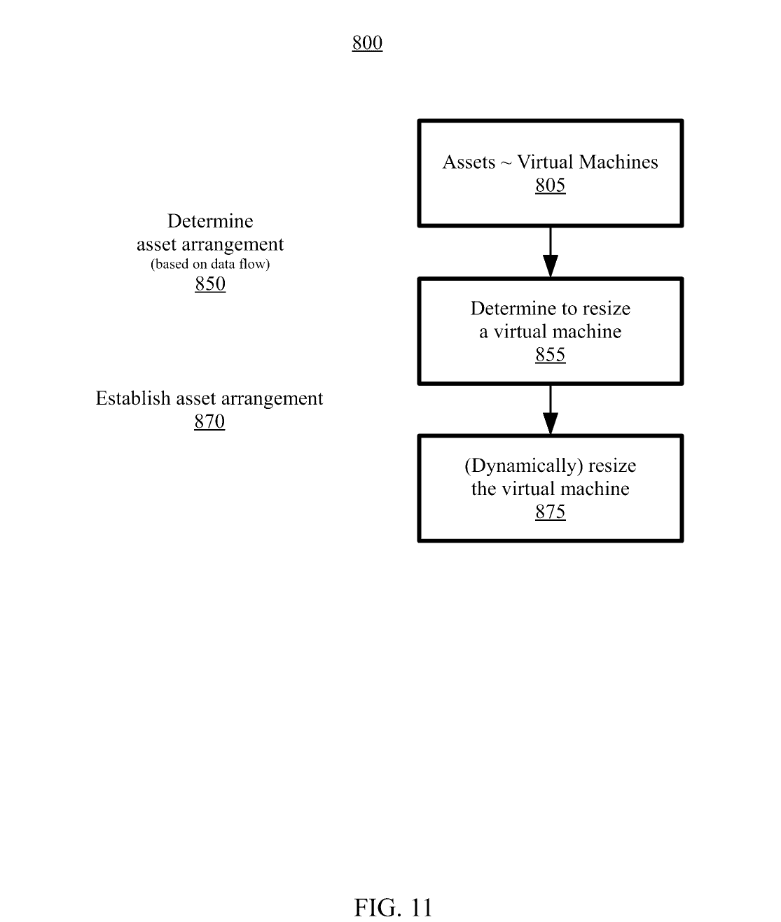

FIG. 11 is a flowchart illustrating a set of asset arrangement operations 800 according to embodiments. The set of asset arrangement operations may be at least a part of determining the asset arrangement (e.g., block 750/850) or establishing the asset arrangement (e.g., block 770/870). Block 805 indicates that the set of assets may include a set of virtual machines. A determination may be made to resize a virtual machine of the set of virtual machines at block 855. The virtual machine of the set of virtual machines may be dynamically resized (e.g., resized without stopping processing for a threshold time period) at block 875. The resized virtual machine can include performance or efficiency benefits to assist in alleviating potential bottlenecks.

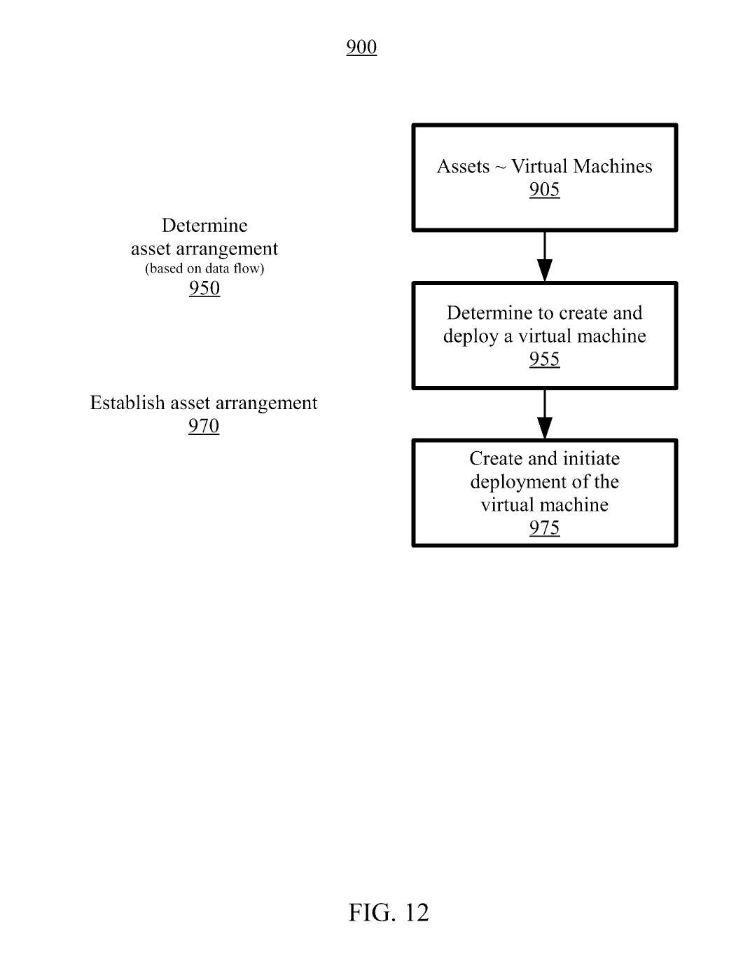

FIG. 12 is a flowchart illustrating a set of asset arrangement operations 900 according to embodiments. The set of asset arrangement operations may be at least a part of determining the asset arrangement (e.g., block 750/850/950) or establishing the asset arrangement (e.g., block 770/870/970). Block 905 indicates that the set of assets may include a set of virtual machines. A determination may be made to both create and deploy a virtual machine of the set of virtual machines at block 955. Both creating and initiating deployment of the virtual machine of the set of virtual machines may occur at block 975. The virtual machine may use its processing power to account for at least a portion of an influx of demand.

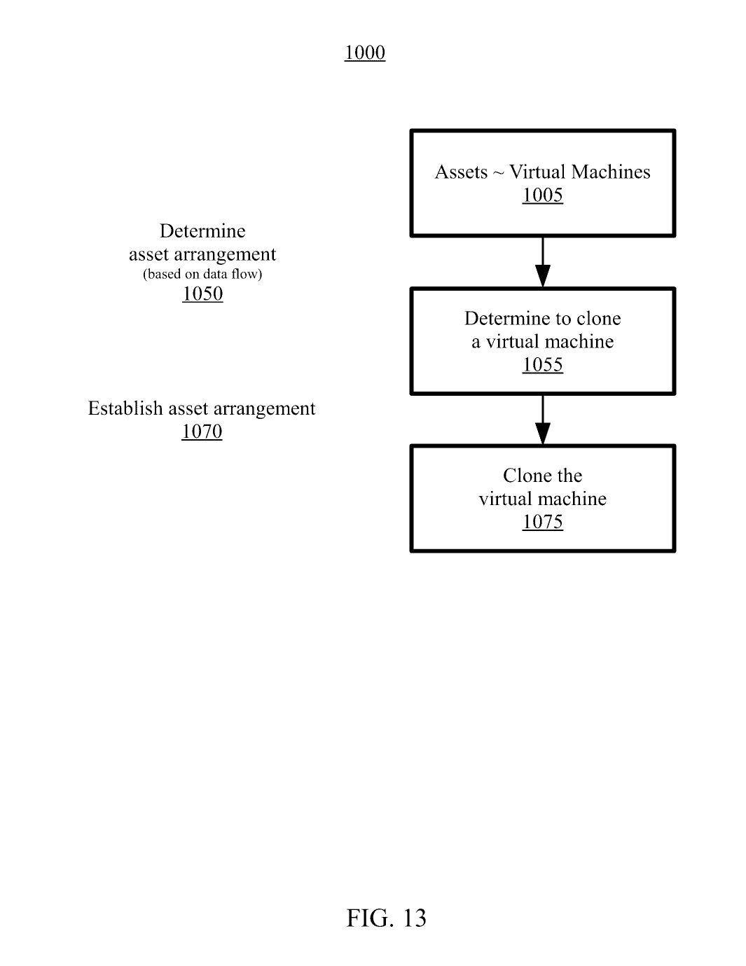

FIG. 13 is a flowchart illustrating a set of asset arrangement operations 1000 according to embodiments. The set of asset arrangement operations may be at least a part of determining the asset arrangement (e.g., block 750/850/950/1050) or establishing the asset arrangement (e.g., block 770/870/970/1070). Block 1005 indicates that the set of assets may include a set of virtual machines. A determination may be made to clone a first virtual machine of the set of virtual machines at block 1055. Cloning the first virtual machine of the set of virtual machines may occur at block 1075. Cloning the first virtual machine of the set of virtual machines may establish a second virtual machine having a set of like processing elements with respect to the first virtual machine. As such, the second virtual machine may relieve the first virtual machine of at least a portion of its workload (e.g., by processing similar data). Such cloning may have positive impacts with respect to potential bottlenecks (e.g., performance or efficiency benefits).

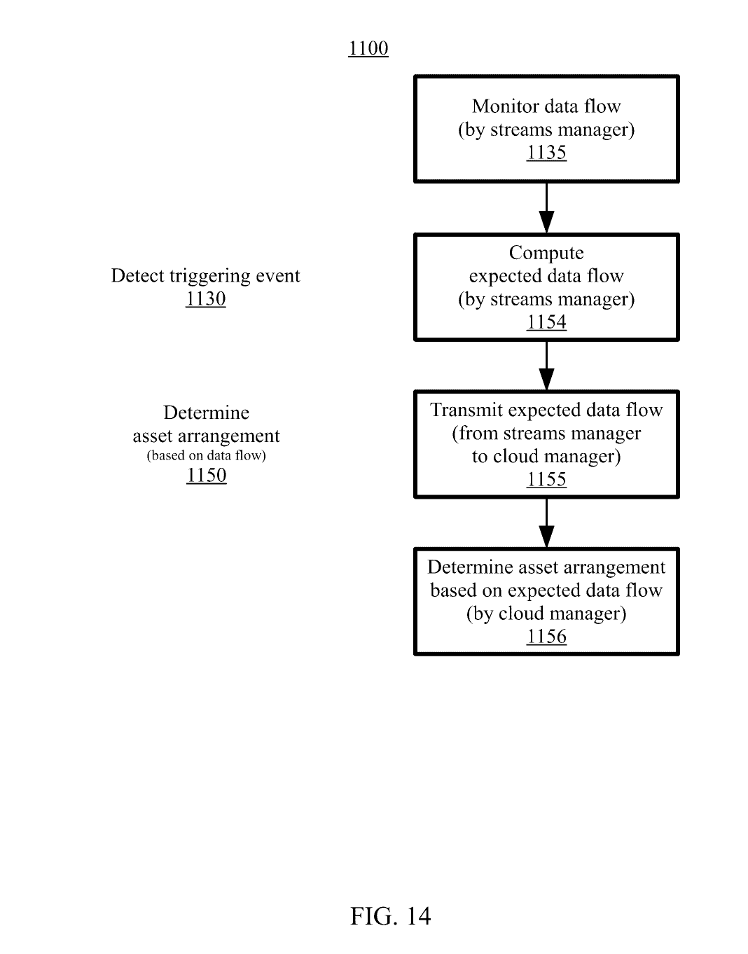

FIG. 14 is a flowchart illustrating a set of asset arrangement operations 1100 according to embodiments. The set of asset arrangement operations may be at least a part of detecting the triggering event (e.g., block 730/1130) or determining the asset arrangement (e.g., block 750/850/950/1050/1150). A streams manager may monitor (e.g., observe) the data flow of the stream of tuples at block 1135. The streams manager can compute (e.g., by analyzing the data flow) an expected data flow of the stream of tuples at block 1154 (e.g., transform the data flow into the expected data flow). The expected data flow of the stream of tuples may be transmitted (e.g., pushed) from the streams manager to a cloud manager at block 1155. In certain embodiments, the expected data flow of the stream of tuples may be pulled by the cloud manager. In various embodiments, a publish-subscribe model may be utilized. The cloud manager can determine the asset arrangement based on the expected data flow of the stream of tuples at block 1156.

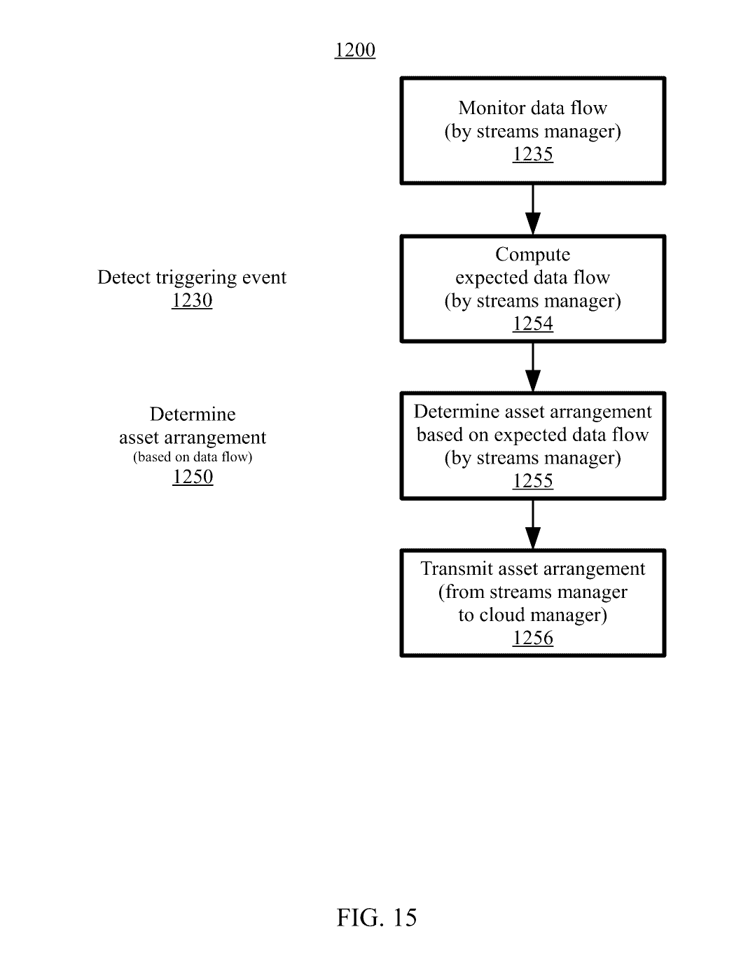

FIG. 15 is a flowchart illustrating a set of asset arrangement operations 1200 according to embodiments. The set of asset arrangement operations may be at least a part of detecting the triggering event (e.g., block 730/1230) or determining the asset arrangement (e.g., block 750/850/950/1050/1250). A streams manager may monitor (e.g., observe) the data flow of the stream of tuples at block 1235. The streams manager can compute (e.g., by analyzing the data flow) an expected data flow of the stream of tuples at block 1254 (e.g., transform the data flow into the expected data flow). The streams manager can determine the asset arrangement based on the expected data flow of the stream of tuples at block 1255. The asset arrangement may be transmitted (e.g., pushed) from the streams manager to a cloud manager at block 1256. In certain embodiments, the asset arrangement may be pulled by the cloud manager. In various embodiments, a publish-subscribe model may be utilized.

In addition to embodiments described above, other embodiments having fewer operational steps, more operational steps, or different operational steps are contemplated. Also, some embodiments may perform some or all of the above operational steps in a different order. In embodiments, operational steps may be performed in response to other operational steps. The modules are listed and described illustratively according to an embodiment and are not meant to indicate necessity of a particular module or exclusivity of other potential modules (or functions/purposes as applied to a specific module).

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Many modifications and variations may be apparent to those of ordinary skill in the art without departing from the scope and spirit of the described embodiments. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Embodiments according to this disclosure may be provided to end-users through a cloud-computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud-computing resources are provided to a user on a pay-per-use basis, where users are charged only for the computing resources actually used (e.g., an amount of storage space used by a user or a number of virtualized systems instantiated by the user). A user can access any of the resources that reside in the cloud at any time, and from anywhere across the Internet. In context of the present disclosure, a user may access applications or related data available in the cloud. For example, the nodes used to create a stream computing application may be virtual machines hosted by a cloud service provider. Doing so allows a user to access this information from any computing system attached to a network connected to the cloud (e.g., the Internet).

Embodiments of the present disclosure may also be delivered as part of a service engagement with a client corporation, nonprofit organization, government entity, internal organizational structure, or the like. These embodiments may include configuring a computer system to perform, and deploying software, hardware, and web services that implement, some or all of the methods described herein. These embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to exemplary embodiments, other and further embodiments of the invention may be devised without departing from the basic scope thereof, and the scope thereof is determined by the claims that follow. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A system for processing a stream of tuples by a plurality of processing elements operating on a shared pool of configurable computing resources having a set of assets, the system comprising:
a memory having a set of computer readable computer instructions, and
a processor for executing the set of computer readable instructions, the set of computer readable instructions including:
receiving the stream of tuples to be processed by the plurality of processing elements operating on the shared pool of configurable computing resources having the set of assets;
detecting a triggering event which corresponds to a data flow of the stream of tuples;
determining, based on the data flow of the stream of tuples, an asset arrangement with respect to the set of assets; and
establishing, for processing the stream of tuples by the plurality of processing elements operating on the shared pool of configurable computing resources having the set of assets, the asset arrangement with respect to the set of assets.

2. The system of claim 1, further comprising:
processing the stream of tuples by the plurality of processing elements operating on the shared pool of configurable computing resources having the set of assets.

3. The system of claim 1, wherein detecting the triggering event which corresponds to the data flow of the stream of tuples includes:
receiving an influx of demand which corresponds to the data flow of the stream of tuples.

4. The system of claim 1, wherein detecting the triggering event which corresponds to the data flow of the stream of tuples includes:
collecting a data flow value of the data flow;
comparing the data flow value with a threshold value; and
determining the data flow value exceeds the threshold value.

5. The system of claim 1, wherein determining, based on the data flow of the stream of tuples, the asset arrangement with respect to the set of assets includes:
utilizing an expected data flow of the stream of tuples, wherein the data flow includes a first set of locations of the stream of tuples, and wherein the expected data flow includes a second set of locations of the stream of tuples.

6. The system of claim 1, wherein:
the set of assets includes a set of virtual machines;
determining the asset arrangement includes determining to resize a virtual machine of the set of virtual machines; and
establishing the asset arrangement includes dynamically resizing the virtual machine of the set of virtual machines.

7. The system of claim 1, wherein:
the set of assets includes a set of virtual machines;
determining the asset arrangement includes determining to both create and deploy a virtual machine; and
establishing the asset arrangement includes both creating and initiating deployment of the virtual machine.

8. The system of claim 1, wherein:
the set of assets includes a set of virtual machines;
determining the asset arrangement includes determining to clone a first virtual machine of the set of virtual machines; and
establishing the asset arrangement includes cloning the first virtual machine of the set of virtual machines to establish a second virtual machine having a set of like processing elements with respect to the first virtual machine.

9. The system of claim 1, wherein determining, based on the data flow of the stream of tuples, the asset arrangement with respect to the set of assets includes:
generating, using a machine learning technique, a data-flow-pattern which is based on historical data flow and configured to predict future data flow; and
determining, based on the data-flow-pattern, the asset arrangement.

10. The system of claim 1, wherein detecting the triggering event which corresponds to the data flow of the stream of tuples includes:
monitoring, by a streams manager, the data flow of the stream of tuples; and
wherein determining, based on the data flow of the stream of tuples, the asset arrangement with respect to the set of assets includes:
computing, by the streams manager, an expected data flow of the stream of tuples,
transmitting, from the streams manager to a cloud manager, the expected data flow of the stream of tuples, and
determining, by the cloud manager, the asset arrangement based on the expected data flow of the stream of tuples.

11. The system of claim 1, wherein detecting the triggering event which corresponds to the data flow of the stream of tuples includes:
monitoring, by a streams manager, the data flow of the stream of tuples; and
wherein determining, based on the data flow of the stream of tuples, the asset arrangement with respect to the set of assets includes:
computing, by the streams manager, an expected data flow of the stream of tuples,
determining, by the streams manager, the asset arrangement based on the expected data flow of the stream of tuples, and
transmitting, from the streams manager to a cloud manager, the asset arrangement.

12. The system of claim 2, further comprising:
metering use of the plurality of processing elements operating on the shared pool of configurable computing resources having the set of assets; and
generating an invoice based on the metered use.

13. A computer program product for processing a stream of tuples by a plurality of processing elements operating on a shared pool of configurable computing resources having a set of assets, the computer program product comprising a computer readable storage medium having program instructions embodied therewith, wherein the computer readable storage medium is not a transitory signal per se, the program instructions executable by a processor to cause the processor to perform a method comprising:
receiving the stream of tuples to be processed by the plurality of processing elements operating on the shared pool of configurable computing resources having the set of assets;
detecting a triggering event which corresponds to a data flow of the stream of tuples;
determining, based on the data flow of the stream of tuples, an asset arrangement with respect to the set of assets; and
establishing, for processing the stream of tuples by the plurality of processing elements operating on the shared pool of configurable computing resources having the set of assets, the asset arrangement with respect to the set of assets.

14. The computer program product of claim 13, further comprising:
processing the stream of tuples by the plurality of processing elements operating on the shared pool of configurable computing resources having the set of assets.

15. The computer program product of claim 13, wherein detecting the triggering event which corresponds to the data flow of the stream of tuples includes:
receiving an influx of demand which corresponds to the data flow of the stream of tuples.

16. The computer program product of claim 13, wherein determining, based on the data flow of the stream of tuples, the asset arrangement with respect to the set of assets includes:
utilizing an expected data flow of the stream of tuples, wherein the data flow includes a first set of locations of the stream of tuples, and wherein the expected data flow includes a second set of locations of the stream of tuples.

17. The computer program product of claim 13, wherein determining, based on the data flow of the stream of tuples, the asset arrangement with respect to the set of assets includes:
generating, using a machine learning technique, a data-flow-pattern which is based on historical data flow and configured to predict future data flow; and
determining, based on the data-flow-pattern, the asset arrangement.

18. The computer program product of claim 13, wherein detecting the triggering event which corresponds to the data flow of the stream of tuples includes:
monitoring, by a streams manager, the data flow of the stream of tuples.

19. The computer program product of claim 13, wherein the program instructions are stored in a computer readable storage medium in a data processing system, and wherein the program instructions were downloaded over a network from a remote data processing system.

20. The computer program product of claim 13, wherein the program instructions are stored in a computer readable storage medium in a server data processing system, and wherein the program instructions are downloaded over a network to a remote data processing system for use in a computer readable storage medium with the remote data processing system.
